(19) United States
(12) Patent Application Publication
(10) Pub. No.: US 2022/0386421 A1
(43) Pub. Date: Dec. 1, 2022

(54) HEATING DEVICE FOR CALENDER CYLINDERS

(71) Applicant: PHT - PETRELLI HEATING TECHNOLOGIES S.R.L., Rozzano (IT)

(72) Inventor: Patrizio PETRELLI, Varese (IT)

(73) Assignee: PHT - PETRELLI HEATING TECHNOLOGIES S.R.L., Rozzano (IT)

(21) Appl. No.: 17/824,100

(22) Filed: May 25, 2022

(30) Foreign Application Priority Data
May 25, 2021 (IT) 102021000013475

(51) Int. Cl. H05B 3/46; H05B 3/00

(52) U.S. Cl. CPC H05B 3/46; H05B 3/0095; H05B 2203/007

(57) ABSTRACT

A heating device for calender cylinders, comprising a core cylinder arranged coaxially in a cylinder adapted to support a plurality of heating elements; the core cylinder and the cylinder adapted to support the heating elements are configured to be accommodated in a fixed manner within a rotating calender cylinder; the core cylinder has an inlet for the passage of air which is adapted to make air flow and gather inside the core cylinder.

### CROSS-REFERENCE TO RELATED APPLICATIONS

This application claims priority to Application IT 102021000013475 filed on May 25, 2021.

### BACKGROUND OF THE DISCLOSURE

The present invention relates to a heating device for calender cylinders.

As is known, in calender cylinders the heating method commonly used is the one based on diathermic oil.

As is known, the calender is a machine tool constituted by one or more rotating cylinders, made of steel or cast iron, between which the material to be processed is made to pass. It is normally used in the rubber, paper, textile and in metallurgy industry.

Calender cylinders are normally heated by means of diathermic oil, which is heated by means of electric resistance heaters or gas chambers. As an alternative, calenders can also have direct electric heating.

The oil-based heating system forces the installation of pumping assemblies, a high-pressure circuit, a hydraulic control unit, rotating joints, and the process requires periodic maintenance and therefore consequent costs, in addition to any machine downtimes for said maintenance.

Furthermore, in calenders heated with diathermic oil it is difficult to adjust the temperature along the length of the cylinder, since it is quite complicated to be able to have regions at differentiated temperature along the length of the cylinder.

Moreover, the drawback in calenders heated with diathermic oil is that they do not have high precision and uniformity in heating along the extension of the cylinder.

Calenders are also known which have infrared heaters supported by a core cylinder which is accommodated in a fixed manner inside the rotating calender cylinder.

The presence of the infrared heating elements allows to heat the calender cylinder after stresses externally and concentrically to the core cylinder for supporting the heating elements in an effective manner and with reduced costs, owing to the absence of oil pumping assemblies, hydraulic control unit, high-pressure circuits and rotating joints.

However, even this solution has drawbacks, which are mainly due to the fact that it is rather difficult to control the air flow inside the core cylinder and therefore ensure adequate air circulation; moreover, the situation described above does not allow an adequate passage of the power supply cables of infrared heaters without interfering with the flow of the air.

Moreover, the solution of the known type has a drawback which is due to the fact that it does not allow the cylinder adapted to support infrared heating elements to undergo dilation. In this case, in fact, the fixing of the heating element supporting cylinder to the core cylinder is fixed and therefore does not allow to consider inevitable thermal dilations.

### BRIEF SUMMARY OF THE DISCLOSURE

The aim of the present invention is to provide a heating device for calender cylinders that allows to distribute rationally the air inside the core cylinder.

Within this aim, an object of the present invention is to provide a heating device for calender cylinders in which the power supply cables that are made to pass within the core cylinder are arranged tidily.

Another object of the present invention is to provide a heating device for calender cylinders in which the fixing of the heating element supporting cylinder with respect to the core cylinder must consider thermal dilations. A further object of the present invention is to provide a heating device for calender cylinders that is highly reliable, relatively simple to provide and at competitive costs.

This aim, these objects and others which will become better apparent hereinafter are achieved by a heating device for calender cylinders, comprising a core cylinder arranged coaxially in a cylinder adapted to support a plurality of heating elements, said core cylinder and said cylinder adapted to support said heating elements being configured to be accommodated in a fixed manner within a rotating calender cylinder, characterized in that said core cylinder has an inlet for the passage of air which is adapted to make air flow and gather inside said core cylinder.

### BRIEF DESCRIPTION OF THE SEVERAL VIEWS OF THE DRAWINGS

Further characteristics and advantages of the invention will become better apparent from the description of a preferred embodiment of the device according to the invention, illustrated by way of non-limiting example in the accompanying drawings, wherein:

FIG. 1 is a longitudinal sectional view of the calender heating device according to the present invention;

FIG. 2 is a further longitudinal sectional view of the calender heating device according to the present invention;

FIG. 3 is a further partial longitudinal sectional view of the calender heating device according to the present invention shown in FIG. 1;

FIG. 4 is a further partial longitudinal sectional view of the calender heating device according to the present invention shown in FIG. 2.

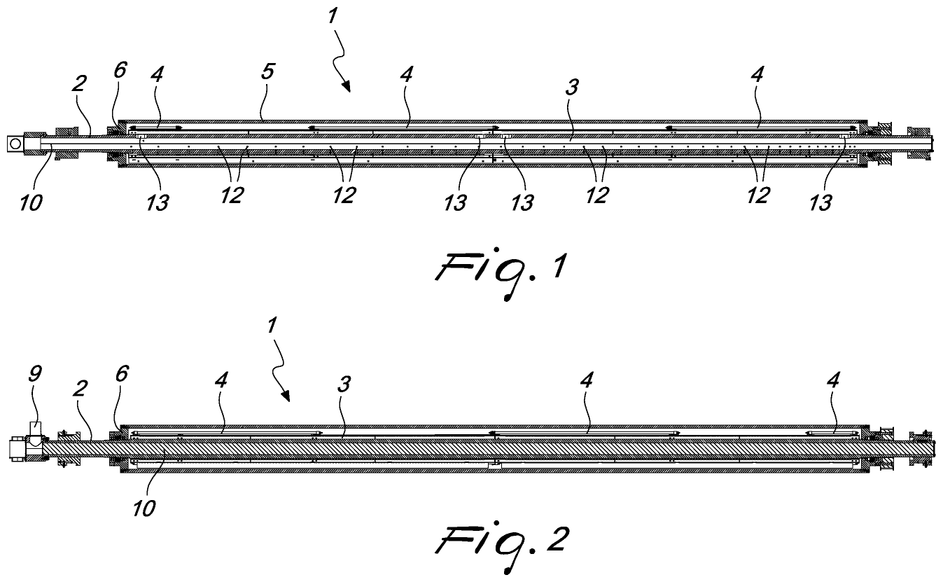

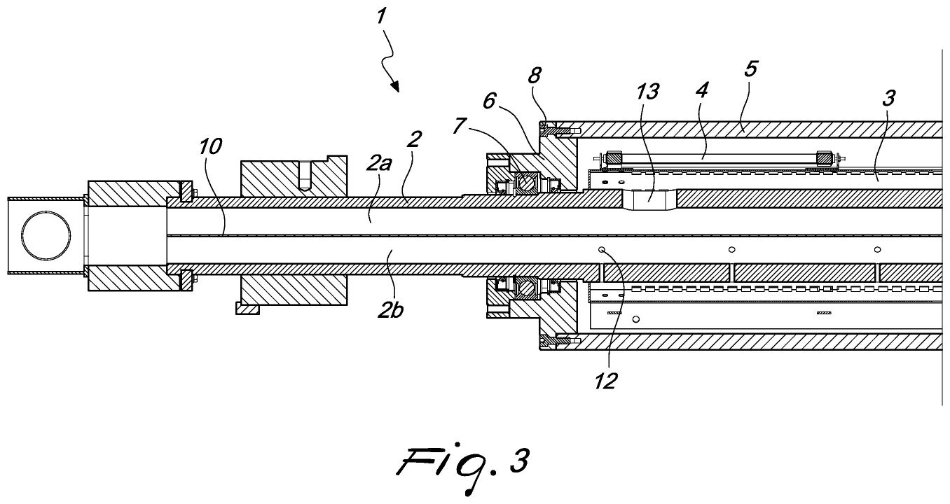

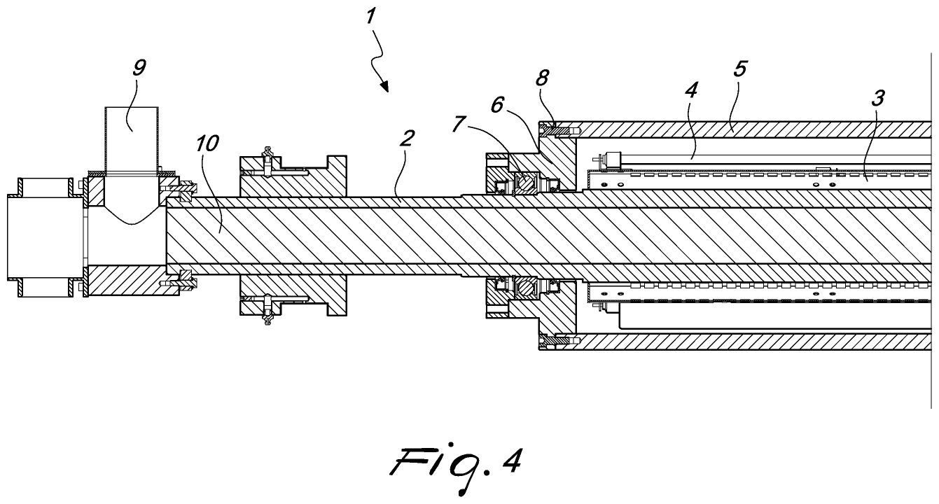

### DETAILED DESCRIPTION OF THE DISCLOSURE

With reference to the figures, the heating device for calender cylinders according to the invention is generally designated by the reference numeral 1. The device comprises a core cylinder 2, which is internally hollow and adapted to support a cylinder 3, which is arranged coaxially thereto, and is adapted to support a plurality of heating elements 4, provided in the form of infrared heaters.

Conveniently, the core cylinder 2 and the cylinder 3 for supporting heating elements 4 are accommodated coaxially within a rotating calender cylinder 5.

The core cylinder 2 is arranged so as to be fixed with respect to the rotating calender cylinder 5, after passing through a head element 6 provided with bearings 7, so that the rotating calender cylinder 5 can rotate about the core cylinder 2 and the cylinder for supporting the heating elements 4.

The head element 6 is fixed by means of bolts 8 to the rotating calender cylinder 5.

Conveniently, the core cylinder 2 has an air passage inlet 9, which allows to convey air into the hollow core cylinder 2.

Inside the hollow core cylinder 2 there is a partition 10 which allows to separate the cylinder into two halves and therefore allow the passage of cables in one half and the unhindered passage of air in the other half.

In particular, the half 2a of the cylinder is the one intended, for example, for the passage of the cables.

The half 2b of the core cylinder 2 is instead preset for the passage of air and is provided with a plurality of holes 12 with increasing perforation, i.e., with a number of holes that increases from one end to the other of the core cylinder 2, therefore with a pitch between the holes that gradually decreases.

Specifically, the cylinder 3 for supporting heating elements 4 is coupled to the core cylinder 2, coaxially thereto, so that it is possible to have a sliding motion with respect to the core cylinder 2 in order to compensate thermal dilations.

Moreover, the core cylinder 2 is provided with slots 13 for the passage of the cables that are made to slide in the half 2a of the internal core cylinder 2.

Finally, an air venting outlet or port 14 is provided at the opposite end of the air inlet 9.

In this manner, the heating device for calender cylinders according to the invention allows to have an optimum distribution of the air along the inside of the core cylinder, in addition to allowing to absorb the dilation of the cylinder that supports the heating elements with respect to the core cylinder.

Moreover, the partition provided inside the core cylinder allows to separate the cylinder internally into two regions, one dedicated to the passage of the cables and the other dedicated to the passage of air.

In practice it has been found that the device according to the invention fully achieves the intended aim and objects.

The device thus conceived is susceptible of numerous modifications and variations, all of which are within the scope of the accompanying claims.

All the details may furthermore be replaced with other technically equivalent elements.

In practice, the materials used, as well as the contingent shapes and dimensions, may be any according to the requirements and the state of the art.

The disclosures in Italian Patent Application No. 102021000013475 from which this application claims priority are incorporated herein by reference.

1. A heating device for calender cylinders, comprising a core cylinder arranged coaxially in a cylinder adapted to support a plurality of heating elements, said core cylinder and said cylinder adapted to support said heating elements being configured to be accommodated in a fixed manner within a rotating calender cylinder, wherein said core cylinder has an inlet for a passage of air which is adapted to make air flow and gather inside said core cylinder.

2. The calender cylinder heating device according to claim 1, wherein said core cylinder has, on an outer surface, a plurality of holes arranged with a decreasing pitch.

3. The heating device according to claim 1, wherein said cylinder adapted to support the heating elements is fixed to said core cylinder so as to be able to have sliding as a consequence of dilation.

4. The heating device according to claim 1, wherein said core cylinder comprises slots for the passage of the cables.

5. The heating device according to claim 1, further comprising an outlet for venting of the air.

6. A rotating calender cylinder, comprising, fixed inside it, a heating device according to claim 1.
